(19) United States
(12) Patent Application Publication
(10) Pub. No.: US 2023/0290533 A1
(43) Pub. Date: Sep. 14, 2023

(54) X-Ray Scanning with Variable Resolution

(71) Applicant: VIKEN DETECTION CORPORATION, Burlington, MA (US)

(72) Inventor: Peter J. Rothschild, Newton, MA (US)

(21) Appl. No.: 18/245,330

(22) PCT Filed: Sep. 16, 2021
(86) PCT No.: PCT/US2021/050762

§ 371 Date: Mar. 14, 2023

Related U.S. Application Data
(60) Provisional application No. 63/079,333, filed on Sep. 16, 2020.
(60) Provisional application No. 63/147,938, filed on Feb. 10, 2021.

(51) Int. Cl. G21K 1/04; G01V 5/00; G21K 1/10

(52) U.S. Cl. CPC G21K 1/043; G01V 5/0025; G21K 1/10

(57) ABSTRACT

An x-ray scanning assembly includes a disk chopper wheel configured to be irradiated by an x-ray beam and to block x-ray radiation of the x-ray beam, the wheel having a rim and a center. The disk chopper wheel defines therein two or more radial slits extending radially toward a rim and a center of the wheel, the slits configured to pass x-ray radiation of the x-ray beam therethrough and having at least two respective, distinct widths. An x-ray beam collimation system includes an x-ray source configured to output x-ray radiation; a collimator configured to receive the x-ray radiation form a collimated x-ray fan beam to be received at a chopper wheel. The collimated x-ray fan beam has a cross-sectional length and a cross-sectional width, smaller than the length, measured at the chopper wheel. The collimator includes a width adjustor configured to adjust width of the fan beam.

### RELATED APPLICATIONS

This application claims the benefit of U.S. Provisional Application No. 63/079,333, filed on Sep. 16, 2020, and U.S. Provisional Application No. 63/147,938, filed on Feb. 10, 2021. The entire teachings of the above applications are incorporated herein by reference.

### BACKGROUND

X-ray backscatter imaging has been used for detecting concealed contraband, such as drugs, explosives, and weapons, since the late 1980's. Unlike traditional transmission x-ray imaging that creates images by detecting the x-rays penetrating through a target object, backscatter imaging uses reflected or scattered x-rays to create the image.

An example chopper wheel that creates the scanning pencil beam used in a backscatter x-ray imaging instrument may include a tungsten outer disk, typically with an aluminum inner hub, defining one or more radial slits. A fan beam of x-rays can be incident on the disk, illuminating a strip on one side of the disk. Only one of the radial slits may be illuminated at any given time, allowing a beam of x-rays to pass though the slit.

A scanning pencil beam used for x-ray backscatter imaging can also be used to create a transmission image with a transmission detector present.

### SUMMARY

In the last few years, handheld x-ray backscatter imaging devices have been introduced into the market, enabling an operator to inspect suspect vehicles, packages, or other target objects quickly and conveniently.

If the scanning x-ray pencil beam is relatively larger in its cross-sectional area, then signal-to-noise ratio in a resulting signal and image can be improved. On the other hand, a relatively larger scanning x-ray pencil beam causes resolution in transmission or backscatter images to be reduced due to the larger cross-sectional area. Further, scanning applications of a given x-ray scanning system may vary widely, and the balance of benefits of a smaller or larger pencil beam can change from application to application. Thus, a better solution is needed to enable x-ray scanning systems to take advantage of both smaller and larger x-ray pencil scanning beams selectively.

In general, some embodiments disclosed in this application relate to a novel chopper disk that enables images of varying resolution to be acquired simultaneously using a scanning pencil beam of x-rays.

Generally, in some embodiments, a modified disk has two slits (also “slit apertures,” as used herein) of a first, equal or standard width and two slits of second, reduced width. As slits move across a beam illumination strip, beams of regular, standard width sweep from left to right. As alternating reduced-width slits move across illumination strip, alternating beams of reduced width sweep from left to right. Such an embodiment of chopper disk will therefore create two regular width sweeping pencil beams per rotation of the chopper disk, alternating with two narrower sweeping pencil beams. Since the resolution of an x-ray imaging system that uses a scanning beam is defined by the width of the beam at the point at which it interacts with the object being imaged, such an imaging system will produce image lines with alternating high/low imaging resolution. This can allow two different images to be produced from a given x-ray scan, a first image with relatively greater target penetration and relatively lower resolution from the standard-width slits, and a second image with relatively lesser target penetration and relatively greater resolution from the reduced-width slits.

A chopper disk (or “disk chopper wheel,” as also used herein) assembly can define two or more aperture slits, wherein the two or more slits have at least two or more different respective defining width dimensions. The disk may define alternating wide and narrow slits, at least one narrower slit, and/or at least one wider slit. Each slit may have a different width. An imaging system comprising such a chopper disk assembly as described above may include extra interpolated image lines inserted into one or more of the acquired images.

A surface of the disk may be illuminated by an x-ray fan beam at approximately normal (perpendicular) incidence. Alternatively, a surface of the disk may be illuminated by an x-ray fan beam at a non-normal (non-perpendicular) incidence, such as with an angle between a plane of the fan beam and a plane of the disk chopper wheel less than or equal to 45 degrees, 30 degrees, or 15 degrees, for example.

Further in general, embodiments described in this disclosure can include a width-varying mechanism that varies the width of the fan beam that is incident on the chopper disk to vary the resolution, rather than relying on different slit widths to vary the resolution.

In a specific embodiment within the scope of this application, an x-ray scanning assembly includes a disk chopper wheel configured to be irradiated by an x-ray beam and to block x-ray radiation of the x-ray beam, the disk chopper wheel having a rim and a center. The disk chopper wheel defines therein two or more radial slits extending in radial directions toward the rim and toward the center, the two or more radial slits being configured to pass x-ray radiation of the x-ray beam therethrough. The two or more radial slits having at least two respective, distinct widths measured perpendicularly to the radial directions.

An x-ray scanning system that includes the x-ray scanning assembly described above may also include an x-ray source configured to output the x-ray radiation of the x-ray beam, a collimator configured to form the x-ray radiation output from the x-ray source such that the x-ray beam is a collimated x-ray fan beam and other features that will become apparent in reference to other embodiments and the remainder of the description, including wherein the collimator has a width adjustor that allows the width of the x-ray fan beam that is incident at the disk chopper wheel to be selectively variable. With an appropriate image generator described herein, resolution of an image produced by the scanning system may, thus, be selected.

In another specific embodiment, an x-ray beam collimation system includes an x-ray source configured to output x-ray radiation. The system further includes a collimator configured to receive the x-ray radiation output from the x-ray source and to form the x-ray radiation into a collimated x-ray fan beam to be received at a chopper wheel. The collimated x-ray fan beam has a cross-sectional length and a cross-sectional width measured at a source side of the chopper wheel, and the cross-sectional length is greater than the cross-sectional width. The collimator includes a width adjustor configured to adjust the cross-sectional width of the collimated x-ray fan beam.

An x-ray scanning system comprising the x-ray beam collimation system described above may include a chopper wheel, and the chopper wheel can be a disk chopper wheel. The collimator can be situated between the x-ray source and the disk chopper wheel, allowing for pencil beam size to be selected as a function of fan beam width at the chopper wheel. This can result in the ability to select scanning resolution of the system and signal-to-noise ratio for different applications. Furthermore, such a system may incorporate other features described in connection with the x-ray scanning assembly and system described above.

In another specific embodiment, a method of x-ray scanning includes outputting x-ray radiation from an x-ray source; receiving, at a source side of a disk chopper wheel, the x-ray radiation; and outputting, from an output side of the disk chopper wheel, a sweeping x-ray pencil beam with at least two different x-ray pencil beam sizes for respective beam sweeps of the sweeping x-ray pencil beam, the at least two different x-ray pencil beam sizes corresponding to radial slits, of at least two respective widths defined by the disk chopper wheel, being rotated through the x-ray radiation via a rotation of the disk chopper wheel.

In yet a further specific embodiment, a method of x-ray beam collimation includes outputting x-ray radiation; collimating the x-ray radiation to form a collimated x-ray fan beam to be received at a disk chopper wheel, the collimated x-ray fan beam having a cross-sectional length and a cross-sectional width at a source side of the disk chopper wheel, the cross-sectional length greater than the cross-sectional width; and selectively adjusting, using the collimator, the cross-sectional width of the collimated x-ray fan beam to vary a scan resolution of an x-ray scan.

More generally, an x-ray scanning assembly within the scope of embodiments of this application includes: means for outputting x-ray radiation from an x-ray source; means for receiving, at a source side of a disk chopper wheel, the x-ray radiation; and means for outputting, from an output side of the disk chopper wheel, a sweeping x-ray pencil beam with at least two different x-ray pencil beam sizes for respective beam sweeps of the sweeping x-ray pencil beam, the at least two different x-ray pencil beam sizes corresponding to radial slits, of at least two respective widths defined by the disk chopper wheel, being rotated through the x-ray radiation via a rotation of the disk chopper wheel.

Also more generally, an x-ray beam collimation system within the scope of embodiments of this application includes: means for outputting x-ray radiation; means for collimating the x-ray radiation to form a collimated x-ray fan beam to be received at a disk chopper wheel, the collimated x-ray fan beam having a cross-sectional length and a cross-sectional width at a source side of the disk chopper wheel, the cross-sectional length greater than the cross-sectional width; and means for selectively adjusting, using the collimator, the cross-sectional width of the collimated x-ray fan beam to vary a scan resolution of an x-ray scan.

### BRIEF DESCRIPTION OF THE DRAWINGS

FIG. 1 is a schematic diagram illustrating an embodiment x-ray scanning assembly and an embodiment x-ray scanning system having a disk chopper wheel with slit apertures of at least two distinct widths.

FIG. 2 is a cross-sectional illustration of an embodiment x-ray scanning assembly with a disk chopper wheel having two slits of a relatively lesser width and one slit of a relatively greater width.

FIG. 3A is a cross-sectional diagram of a disk chopper wheel featuring tapered slits that may be used in embodiments.

FIG. 3B is a cross-sectional diagram of an x-ray fan beam that may be produced in embodiments.

FIG. 3C is a perspective-view diagram illustrating a cross section of a pencil beam with height and width that are both adjustable using a combination embodiment.

FIG. 4 (prior art) is a perspective-view schematic illustration of an x-ray imaging system that uses a scanning x-ray beam, which can be used for x-ray backscatter imaging, or for x-ray transmission imaging, or both.

FIG. 5 (prior art) is a perspective-view illustration of an example handheld backscatter x-ray imaging instrument manufactured by Viken Detection™ Corporation that operates at 120 kV end point energy.

FIG. 6 (prior art) is an engineering drawing of an existing disk chopper wheel used to create a scanning pencil beam of x-rays.

FIGS. 7A-7C (prior art) are cross-sectional engineering drawings illustrating an existing disk chopper wheel defining therein radial slit apertures of equal width, with the disk chopper wheel at various stages of a single line scan.

FIG. 8 (prior art) is a cross-sectional engineering diagram of an existing disk chopper wheel defining therein wider slit apertures, all of equal width, which create a wider pencil beam profile.

FIG. 9 is a cross-sectional engineering diagram illustrating a disk chopper wheel that can be used in various embodiments, which defines therein four slit apertures of two different alternating widths, which can give rise to an alternating x-ray pencil beam width profile.

FIG. 10 is a perspective-view diagram illustrating a disk chopper wheel oriented perpendicular to an x-ray fan beam plane.

FIG. 11 is a perspective-view diagram of the disk chopper wheel of FIG. 10, but oriented at a non-perpendicular angle with respect to the x-ray fan beam plane.

FIG. 12 is a schematic diagram illustrating an embodiment x-ray beam collimation system wherein a collimator includes a width adjuster to adjust a width of a fan beam produced by the x-ray beam collimation system. FIG. 12 also illustrates a corresponding embodiment x-ray scanning system.

FIG. 13 is a perspective-view diagram of a collimator having an attenuating plate serving as the width adjuster.

FIG. 14 is a perspective-view diagram illustrating a collimator in which the width adjuster is a set of two attenuating plates working in connection with a collimator slit.

FIG. 15 is a perspective-view diagram of a collimator in which x-ray fan beam width adjustments is provided by an x-ray attenuating volume defining a slot therein, the slot configured to pass x-ray radiation therethrough, where the x-ray attenuating volume is configured to be rotated to align or misalign the slot with incident x-ray radiation received at the attenuating volume.

FIG. 16 is a perspective-view illustration of a collimator having a cylindrical x-ray attenuating volume with a slot defined therein, in which the cylindrical x-ray attenuating volume can be rotated to provide beam width adjustment.

FIG. 17 is a cross-sectional-view diagram of an embodiment x-ray scanning system incorporating the collimator with cylindrical attenuating volume of FIG. 16.

FIGS. 18A-18C are cross-sectional illustrations of the collimator of FIG. 16 in various states of rotation permitting a full beam, partial beam, and no beam to the output, respectively.

FIG. 19 is a schematic diagram illustrating a series of scan lines that can be used by an image generator to form an image, including with interpolated scan lines in various embodiments.

FIG. 20 is a flow diagram illustrating an embodiment procedure for x-ray scanning.

FIG. 21 is a flow diagram illustrating an embodiment procedure for x-ray beam collimation.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

### DETAILED DESCRIPTION

A description of example embodiments follows.

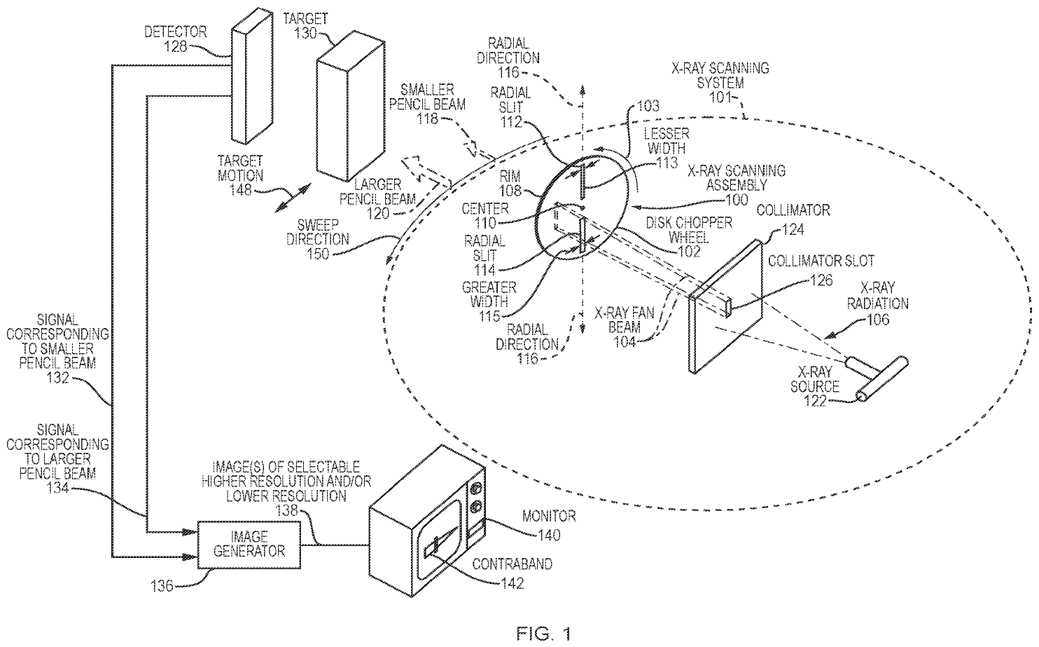

FIG. 1 is a schematic diagram illustrating an embodiment x-ray scanning assembly 100, which is useful for providing x-ray scanning with a selectable, relatively higher resolution or a selectable, lower resolution, or both. The x-ray scanning assembly 100 includes a disk chopper wheel 102 that is configured to be irradiated by an x-ray fan beam 104. The disk chopper wheel 102 has a rim 108 and a center 110. The disk chopper wheel 102 defines therein two radial slits 112, 114. In other embodiments, generally there are provided to or more radial slits, such as three radial slits, four radial slits, or 4-8 radial slits. The radial slits extend in radio directions 116 toward the rim 108 and toward the center 110. As used herein, toward the center and toward the rim need not be exact, but the slits should be radial and extend in the direction of the rim and toward the center to an extent that provides for regular, sweeping, scanning x-ray pencil beam imaging, as will be understood by those of skill in the art. The radial slits 112, 114 are configured to pass x-ray radiation 106 of the x-ray fan beam 104 therethrough. Advantageously, the radial slits 112, 114 have two respective, distinct with, namely a lesser width 113 and a greater width 115, respectively. The widths 113, 115 are measured perpendicularly to the radial directions 116.

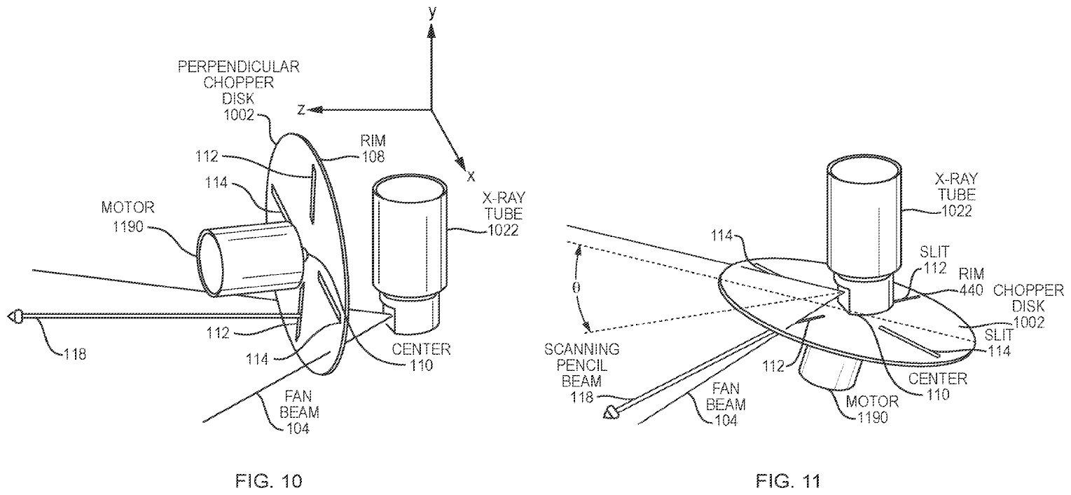

The x-ray scanning assembly 100 can include various other components, such as a motor for turning the disk chopper wheel 102, as illustrated in FIGS. 10-11 and mounting or other attachment components for fixing the center 110 of the disk chopper wheel 102 with respect to other portions of an x-ray scanning assembly or an x-ray scanning system. In general, the x-ray scanning assembly 100 provides, when illuminated by the x-ray fan beam 104, at a source side of the disk chopper wheel 102, closer to the x-ray source 122, a smaller pencil beam 118 output from the wheel 102 when the slit 112 passes through the x-ray fan beam 104, and a larger pencil beam 120 as the slit 114 passes through the x-ray fan beam 104. Advantageously, signals 132, 134, respectively, corresponding to the x-ray sweep of the pencil beams 118, 120, respectively, can be used to provide one or more images of selectable higher resolution and/or lower resolution, respectively, as will be described further hereinafter.

As the disk chopper wheel 102 rotate with a rotation 103, the slits 112, 114 pass through the x-ray fan beam 104, causing sweeps of the smaller pencil beam 118 and larger pencil beam 120 in turn, in a sweep direction 150. These pencil beams 118, 120 pass over a target 130 in order to provide scan lines that can be detected by a transmission detector 128, as is understood by those skilled in the art of x-ray scanning.

In the setup of FIG. 1, the scanning pencil beams are used for transmission images imaging, in which portions of the pencil beams transmitted through the target 130 are detected by the detector 128 to form the images. However, the principles that are illustrated in FIG. 1 are similarly applicable to backscatter imaging, and the same scanning pencil beams 118, 120 can be applied to backscatter imaging. In the case of backscatter imaging, detectors may be placed, for example, between the disk chopper wheel 102 and the target 130, as understood by those of skill in the art. In the case of backscatter imaging, x-rays that are backscattered or reflected from the target 130 are detected as a function of scan position, instead of transmitted x-rays.

As described above, various numbers of the slits 112 of lesser width 113 and the slits 114 of greater width 115 may be provided in embodiment disk chopper wheels 102 and defined thereby. For example, there can be three or more radial slits defined by the disk chopper wheel 102, and at least one of the radial slits can have the relatively lesser width of the at least two respective, distinct widths, and at least two of the radial slits can have the relatively greater width 115. By “relatively lesser with” and “relatively greater with,” as used herein, it is meant that one of the widths is greater than the other, and one of the width is lesser than the other. In other embodiments, there can be three or more radial slits, and at least one can have the relatively greater width, and at least two of the radial slits can have the relatively lesser width. This case is illustrated by the embodiment x-ray scanning assembly described hereinafter in connection with FIG. 2, and the disk chopper wheel described in connection with FIG. 9, for example.

It will be understood from the above description that where there are four or more radial slits defined by the disk chopper wheel, radial slits that are adjacent to each other have can have different widths. In other words, during scanning, radial slits that pass through the x-ray fan beam 104 in turn can have the alternating, respective, distinct widths, such that alternating larger and smaller pencil beams are output. The disk chopper wheel of FIG. 9, described hereinafter, is one example having for radial slits with the alternating radial slits of alternating, distinct width.

FIG. 1 also illustrates an x-ray scanning system 101 that includes the x-ray scanning assembly 100 with the disk chopper wheel 102, along with a collimator 124 and an x-ray source 122. In the system 101, the collimator 124 is in the form of a collimator plate and includes a collimator slot 126. It should be understood that in other embodiments, the collimator 124 may be replaced by other embodiments collimator assemblies or systems to provide collimation.

In the x-ray scanning system 101, the x-ray source 122 is configured to output the x-ray radiation 106 that is used to create or form the x-ray fan beam 104. The collimator 124 is configured to form the x-ray radiation 106 that is output from the source 122 such that the x-ray beam that is received at the disk chopper wheel 102 is an x-ray fan beam that is collimated to form a substantially uniform x-ray fan beam pattern at the incident, or source side of the disk chopper wheel 102. Moreover, other x-ray scanning systems can incorporate other elements illustrated in FIG. 1, such as the detector 128, backscatter detectors (not illustrated in FIG. 1), an image generator 136, and or the monitor 140, for example. Various details of these components will be described further hereinafter.

In some embodiments of the x-ray scanning system 101, the disk chopper wheel 102 may be oriented with a wheel plane containing the chopper wheel being substantially perpendicular relative to a beam plane containing the collimated x-ray fan beam. In other embodiments, the disk chopper wheel 102 may be oriented with a wheel plane containing the chopper wheel being substantially non-perpendicular relative to a beam plane containing the collimated x-ray fan beam. These features, which are optional, are described further hereinafter in connection with FIGS. 10-11.

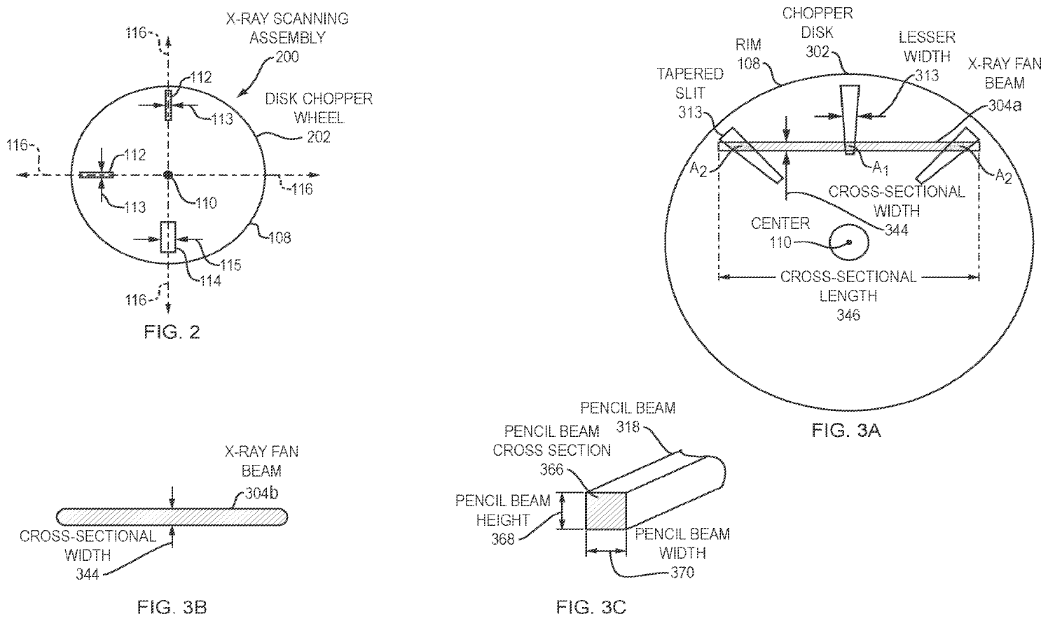

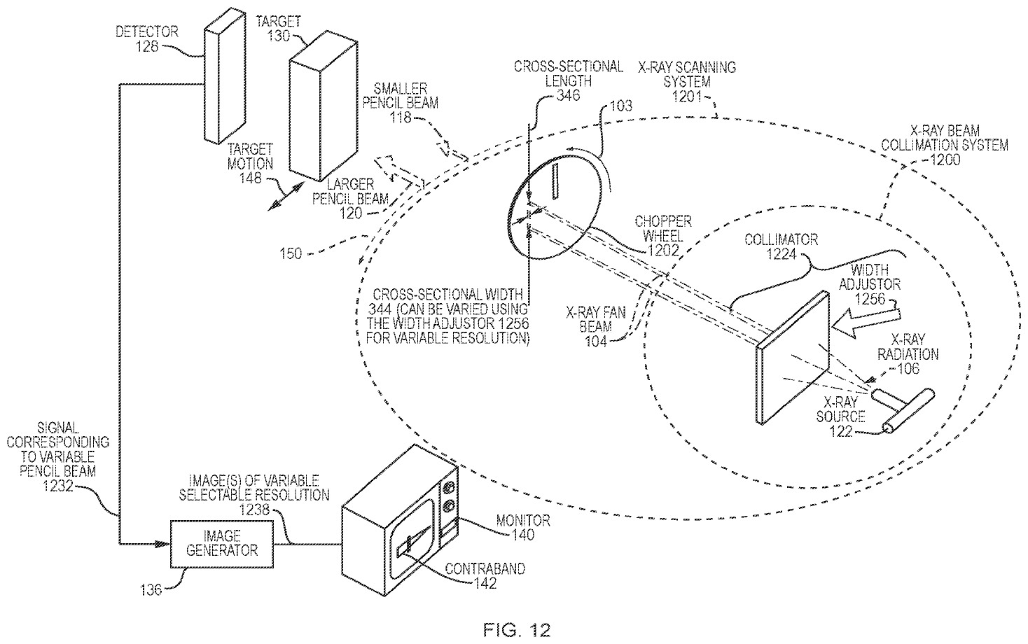

The collimated x-ray fan beam 104 can have a cross-sectional length and a cross-sectional width, measured at the source side of the disk chopper wheel 102, with the cross-sectional length greater than the cross-sectional width, as illustrated in detail in FIG. 3A. The collimator 124 can further include a width adjuster that is configured to adjust the cross-sectional width of the collimated x-ray fan beam, an optional feature that is described in greater detail in connection with FIGS. 12-17 and 18A-18C, for example.

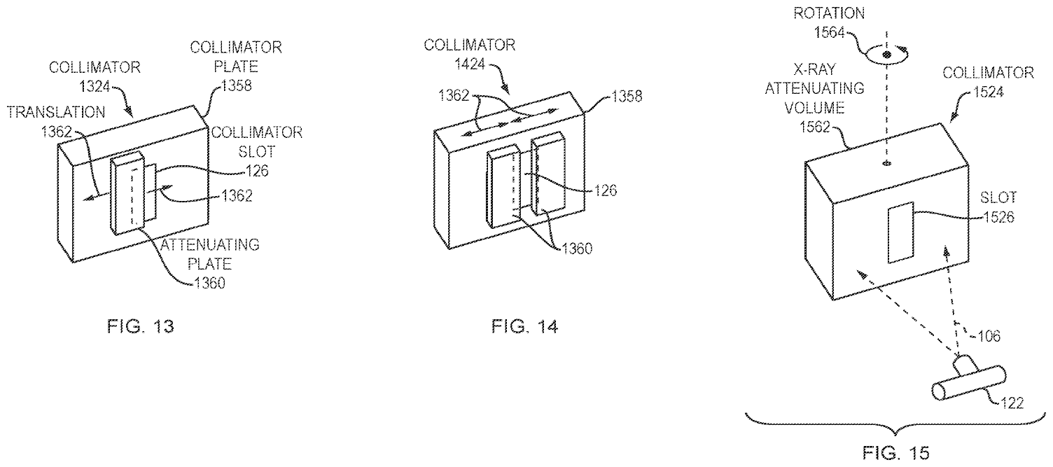

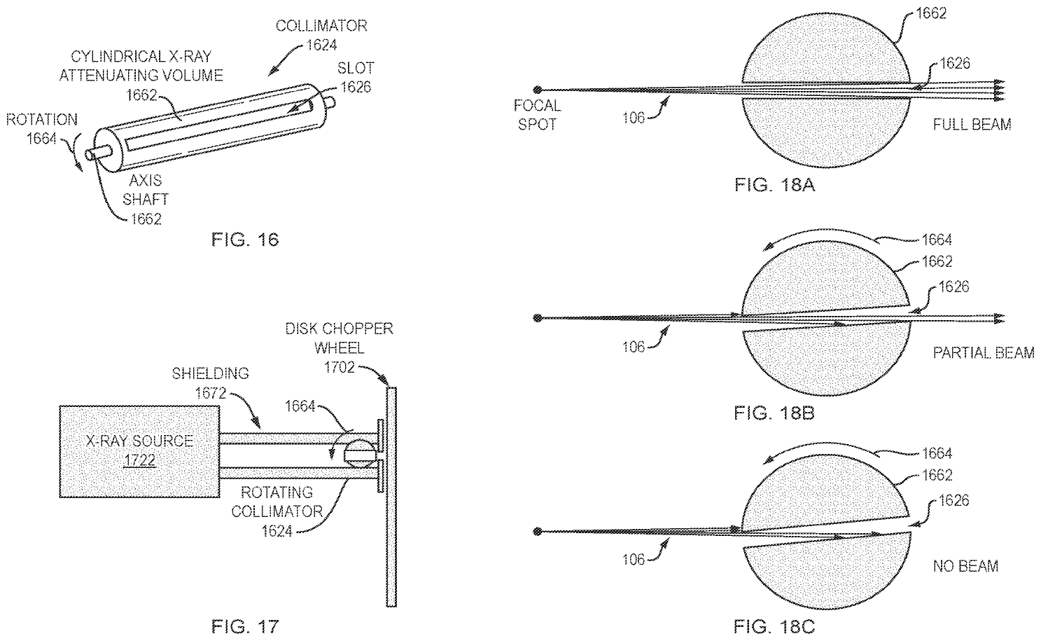

The width adjuster is also referred to herein as a “width adjustment mechanism.” The width adjuster can include at least one x-ray attenuating plate that is configured to block the x-ray radiation and to be translated with respect to the x-ray radiation to adjust the cross-sectional width, as illustrated in FIG. 13, for example. FIG. 14 illustrates an alternative embodiment in which two x-ray attenuating plates work in tandem, being translated to adjust the cross-sectional width. Alternatively, the width adjuster can include, more broadly, an x-ray attenuating volume that is configured to pass the x-ray radiation therethrough, as a function of, and in accordance with, a degree of alignment of a slot defined within the x-ray attenuating volume. The slot is configured to pass the x-ray radiation depending on the alignment. The attenuating volume can be configured to be rotated in order to adjust the cross-sectional with of the x-ray fan beam in accordance with the degree of alignment, as illustrated generally in FIG. 15, and as illustrated with further particularity in relation to a cylindrical attenuating volume that is shown in FIGS. 16, 17, and 18A-18C.

As previously described, the x-ray scanning system 101 can further include a detector. The detector can be configured to detect x-ray radiation transmitted through the target 130, such as the detector 128. Alternatively, the detector can be configured to detect x-ray radiation that is scattered from the target 134 backscatter imaging. This detection occurs as the disk chopper wheel 102 is rotated with the rotation 103. The detector, such as the detector 128 illustrated in FIG. 1, is configured to output a signal 132 corresponding to the smaller pencil beam 118 sweeping through the target 130, and also a signal 134 corresponding to the larger pencil beam 120 and swept through the target 130. Each sweep of a pencil beam corresponds to a scan line that is detected in this manner and can be used to form, collectively, an image of the target 130. It should be understood that the signals 132, 134 are shown as separate lines only to indicate that they pertain to the two different scan beam widths. As will be readily understood by those of skill in the art, both signals 132 and 134 may be transmitted from the detector 128 to the image generator 136 on a single cable. The two signals may be parsed and separated in view of their time of arrival in correspondence with a known position of the disk chopper wheel, for example.

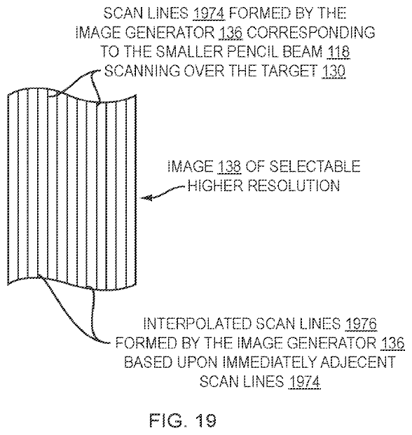

Scan lines are understood by those of skill in the art, and also particular exemplary scan lines are illustrated in FIG. 19. Each scan line corresponds to a sweep of one of the radial slits through the x-ray fan beam 104. The imaging the image generator 136 is configured to receive the signals 132, 134 corresponding to the scan lines and to generate, selectively, an image 138 of relatively lower resolution based on the signals 134 corresponding to scan lines from the radial slit 114 of relatively greater width, and an image of relatively higher resolution and image 138 of relatively higher resolution based on the signals 132 corresponding to scan lines formed by the smaller pencil beam 118 when the narrower slit 112 passes through the x-ray fan beam 104. In other words, an image 138 may be formed by the image generator 136 that is of higher resolution when using the signals 132, and an image 138 of lower resolution may be formed when using the signals 134, corresponding to the larger pencil beam and the wider slit 114 of greater width 150. Thus, the system can enable a user to select to view either the higher-resolution image, or the lower-resolution image, or to view both images on a monitor 140. Illustrated on the monitor 140 is an example item of contraband 142 that is contained within the target 130.

Furthermore, the image generator 136 can be configured to generate one or more interpolated scan lines either (i) between adjacent scanlines from the one or more radial slits of relatively lesser width, or (ii) between adjacent scan lines from the one or more radial slits of relatively greater width, or both. This interpolation is described further hereinafter in connection with FIG. 19.

FIG. 2 is a cross-sectional view of an embodiment x-ray scanning assembly 200. The assembly 200 differs from the assembly 100 of FIG. 1, in that a disk chopper wheel 202 defines therein two of the radial slits 112, having the relatively lesser width 113, and one of the radial slits 114, having the relatively greater width 115. Thus, as illustrated in FIG. 2, the number of slits provided in an embodiment can be flexible. In one example, three smaller with radial slits are provided in a disk chopper wheel, while one radial slits is of wider width and is used for scanning with a different resolution, along with the advantages noted above for a larger pencil beam. On the other hand, in other embodiments, three radial slits of the relatively greater width 115 may be provided, while a single radial slit 112 of smaller width may be used for higher resolution imaging. In this case, a full, lower-resolution image may be formed based upon the three slits 114, and interpolation can be advantageously used between adjacent scans with the wider slit 114 in order to fill in a missing scan line from the lower-resolution image, corresponding to the narrower slit 112 forming a scan line of higher resolution. It will be understood that similar interpolation can occur for a higher-resolution image, whether one relatively narrower slit is provided, or more. Interpolation is described further in connection with FIG. 19.

FIG. 2 also illustrates, in greater detail, that the widths 113, 115 are measured perpendicular to the radial directions 116 at each slit.

FIG. 3A illustrates a disk chopper wheel 302 that features a tapered radial slit 313. The tapered radial slit 313 can advantageously provide uniform pencil beam intensity throughout the scan of the slit 313. Tapering refers to the variable width of slits. In FIG. 3A, the disk chopper wheel 302 includes the tapered slit 313, with the width of the slit increasing from the center 110 of the disk toward the rim 108 of the disk. In other words, the slit 313 has greater width toward the rim of the disk than toward the center of the disk. The tapering of the slit is designed so that the solid angle of the slit, as viewed from a focal spot of the x-ray tube, remains approximately constant through the scan. A first order equation describing this condition is Equation (1):

$$\frac{{A}_{1}}{{D}_{1}^{2}} = \frac{{A}_{2}}{{D}_{2}^{2}}$$

where A₁ and A₂ are the areas of the region where the slit 313 overlaps with the incident illuminating fan beam 304a when the slit 313 is at the center and end of the scan, respectively, and D₁ and D₂ are the respective distances between the x-ray source focal spot (FS) and the centers of the overlap areas A₁ and A₂, when the slit is at the center and end of the scan, respectively. The advantage of the tapering is emphasized by considering a reduction in beam intensity at the extremes if the slits are not tapered. The ratio of beam intensity when the untapered slit is at the center of the fan beam to the intensity when at the end is shown in Equation (2):

$$\frac{{I}_{2}}{{I}_{1}} = \frac{{D}_{2}^{2}}{{D}_{1}^{2}}$$

By using tapered disks with the slit tapering designed specifically so that A₁ and A₂ satisfy Equation (1), the intensities I₁ and I₂ can be made to be equal, and the image brightness and noise characteristics are more uniform across the scan.

FIG. 3A also illustrates a profile of the exterior of an x-ray fan beam 304a that is incident on the disk chopper wheel 302. The profile of the beam 304a is substantially rectangular and has a cross-sectional length 346 and cross-sectional width 344.

FIG. 3B illustrates that an x-ray fan beam 304b that is incident on an embodiment disk chopper wheel can be other than rectangular or perfectly rectangular. The x-ray fan beam 304b has rounded ends, and in other embodiments, the profile may be oval. In this case, the cross-sectional with 344 can be designated as the width at the center of the fan beam 304b. Furthermore, the cross-sectional width in other embodiments can be considered to be the average cross-sectional width across a length of the fan beam, such as across the entire length of the standing, if not otherwise well-defined.

FIG. 3C illustrates an example pencil beam 318 that is considered to be a smaller pencil beam, similar to the smaller pencil beam 118 in FIG. 1. Nonetheless, the dimensions and descriptions provided hereinafter for the pencil beam 318 apply equally to a larger pencil beam. FIG. 3C illustrates a pencil beam cross-section 366 of the beam 318, in which it is made clear that the pencil beam can be considered to have a pencil beam height 368 and a pencil beam width 370. As will be understood by reference to FIG. 1, as a radial slits 112 or 114 passes through the x-ray fan beam 104, a height of the output pencil beam may be considered to be determined by the lesser width 113, or greater width 115, of the radial slit. Thus, the pencil beam height 368 illustrated in FIG. 3C can be advantageously changed or varied based upon the radial slit width. Furthermore, the cross-sectional width 344, which corresponds to the pencil beam width 370, can be varied using a collimator with a width adjuster, as already described, and as described further hereinafter. The width of the x-ray fan beam 104, which can be adjusted in accordance with the described embodiments, can be considered to correspond to the pencil beam with 370.

In embodiments that incorporate both the radial slits of different widths, as illustrated in FIG. 1, and the collimator with width adjuster, as already described, and which will be further described hereinafter in connection with FIG. 12, for example, greater control of beam pencil beam parameters can be provided, in both height and width dimensions. By combining these two aspects of embodiments, adjustable beam collimator and slits with multiple widths, a wider range of resolution and penetration optimizations can be made.

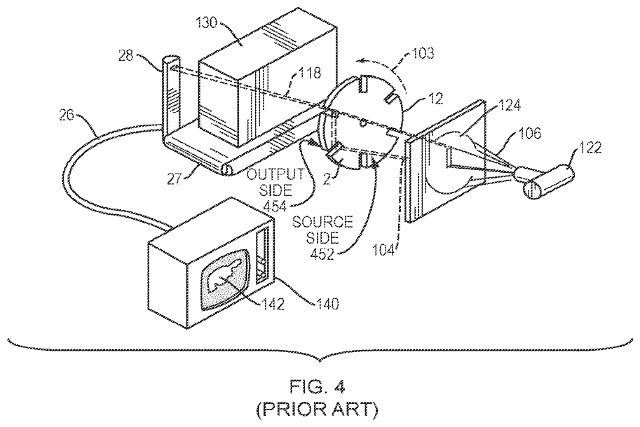

FIG. 4 (prior art) is a perspective-view schematic illustration of an x-ray imaging system that uses a scanning x-ray beam, which can be used for x-ray backscatter imaging, or for x-ray transmission imaging, or both. FIG. 4 provides further context for imaging with a scanning x-ray beam as a background, showing basic principles, of such imaging, such that to the novel features of present embodiments may be understood more fully.

In the system of FIG. 4, a standard x-ray tube 122 generates the x-ray radiation 106 that is incident at an attenuating plate 124. The radiation is collimated into a fan beam 104 by a slot in attenuating plate 124, and the fan beam 104 is incident at a source side 452 of the disk chopper wheel 2, where the source side 452 is the side of the chopper wheel that is closest to the x-ray source 122. The fan beam is then “chopped” into a pencil beam by the rotating “chopper wheel” 2 with slits 12. The pencil beam is output through an output side 454 of the disk chopper wheel (the side opposite the x-ray source 122) and scans over the target object 130 being imaged as the wheel rotates with the rotation 103. The intensity of the x-rays scattered in the backwards direction is then recorded by one or more large-area backscatter detectors (not shown) as a function of the position of the illuminating beam to form a backscatter image. In addition, the intensity of the transmitted x-rays can be recorded by a transmission detector 28 to create a transmission x-ray image simultaneously. A signal cable 26 carries scan line signals from the detector 28 to the monitor 140. By moving the object through the plane containing the scanning beam, either on a conveyor 27 or under its own power, a two-dimensional backscatter image of the object is obtained. Alternately, the object can be stationary, and the imaging system can be moved relative to the object.

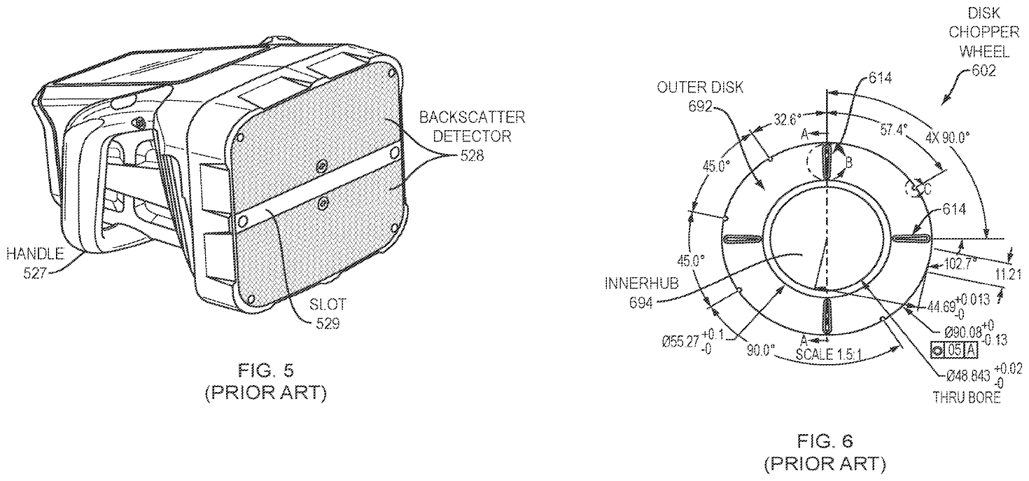

FIG. 5 (prior art) is a perspective illustration of an example of a handheld, 120 kV backscatter x-ray imaging system. In the last few years, handheld x-ray backscatter imaging devices have been introduced into the market, enabling an operator to inspect suspect vehicles, packages, or other target objects quickly and conveniently. These devices have been designed to be relatively compact and lightweight, allowing them to be easily operated for extended periods of time.

The handheld system shown in FIG. 5 includes handles 527 for handheld operation. A scanning pencil beam that is formed within the unit is output through a slot 529 that is formed between upper and lower sections of a backscatter detector 528. The backscatter detector 528 detects x-ray radiation that is reflected or scattered or reflected from a target when the scanning pencil beam is incident at the target.

The variable resolution as provided by variable slit widths and variable collimators, as provided by embodiments herein, is particularly advantageous for handheld applications. For handheld x-ray scanning applications, the same handheld imaging instrument is typically used for a large range of applications, compared with prior-art baggage scanners or vehicle scanners that have typically been used to image the same types of objects at the same distances. A handheld imager may be used to search for insects behind sheetrock walls, in which case high resolution is needed to image fine wires. In the sheetrock wall application, penetration is not an issue. However, the same handheld scanner may be equally well used to look for bulk narcotics concealed in a thick steel differential on a truck, which will require high penetration, and resolution in that case may not be as significant an issue. Therefore, having the ability, as provided by the disclosed embodiments, to adjust the instrument selectively for different missions is now particular advantageous for handheld devices compared with prior-art systems.

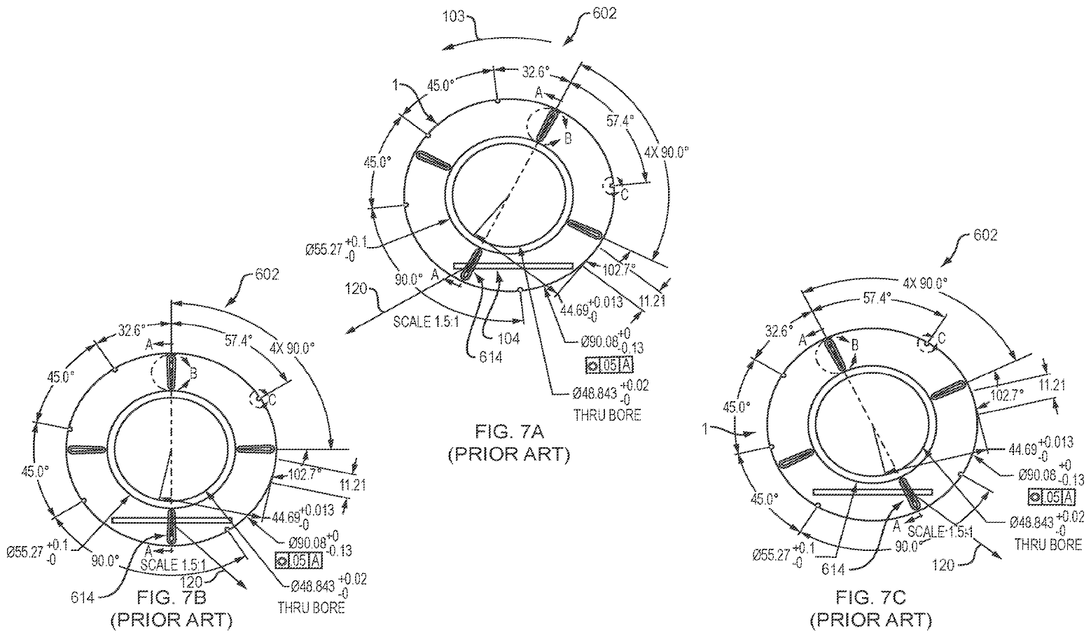

FIG. 6 (prior art) is an example of a disk chopper wheel 602 that can be used to create the scanning pencil beam that is used in the handheld backscatter x-ray imaging instrument shown in FIG. 5. The disk chopper wheel 602 includes a tungsten outer disk 692 and an aluminum inner hub 694, which can typically be made with aluminum. Four radial slits 614 of uniform, greater width are defined within the outer disk 692. A fan beam of x-rays is incident on the outer disk 692. This is particularly illustrated in FIGS. 7A-7C.

FIGS. 7A-7C (prior art) illustrate the existing disk chopper wheel 602 rotating through rotating one of the slits 614 through the fan beam 104. Only one of the radial slits 614 is illuminated at any given time, allowing a beam of x-rays 120, the larger pencil beam, to pass through the slit 614. In FIG. 7A, the illuminated slit 14 has just entered the illumination strip, or in other words intersected with the illumination strip, and the beam of x-rays 120 is pointing to the left. As the wheel rotates in a direction 103, as illustrated in FIG. 7B, the illuminated slit 614 moves across the illumination strip 104, and the beam 120 passes through the midpoint of the scan line and then points to the right as the illuminated slit 614 exits the illumination strip 104, as illustrated in FIG. 7C.

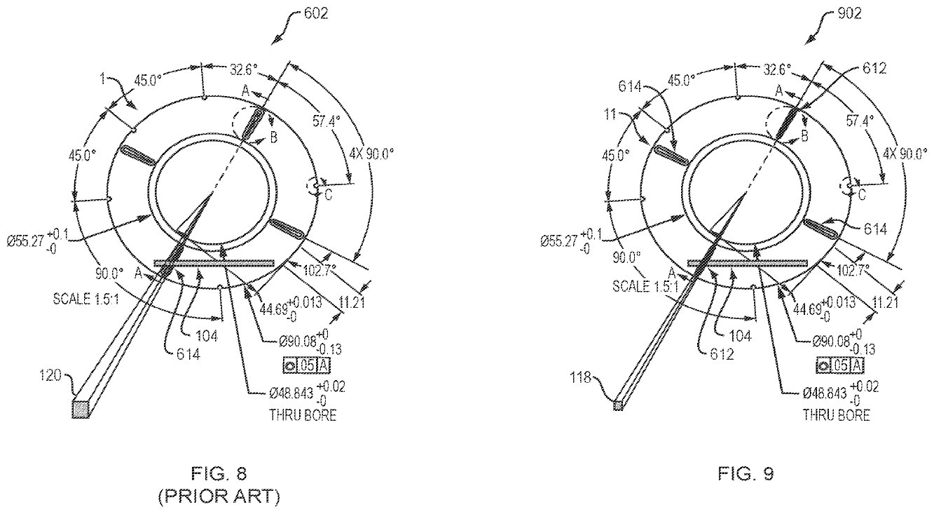

FIG. 8 (prior art) also illustrates the disk chopper wheel 602 of FIGS. 6 and 7A-7C, along with an illustration of the size of the beam 120, which is considered to be of the larger size described in FIG. 1. All four of the slits 614 in this existing disk chopper wheel 602 produce the same size of x-ray pencil beam 120.

FIG. 9 illustrates a modified disk chopper wheel 902, which includes two slits 614 of the larger with, equal to each other, and two slits 612 of a lesser, reduced width. The wheel 902 may be used in connection with the assembly 100 of FIG. 1, for example. The slits 614 produce pencil beams of the size of beam 120, while the reduced with slits 612 produce the smaller pencil beam 118. Because the slits are staggered, with a narrow slit followed by a wider slit and each wider slit followed by a narrow slit, beams 120 and 118 sweep across the target in alternating fashion as alternating reduced with slits 612 move across the illumination strip 104 (also referred to herein as the x-ray fan beam 104)? Alternating beams of reduced with and regular with sleep from left to right in this embodiment disk chopper wheel 902, to regular with sweeping pencil beams (of the larger width) are produced per rotation of the disk chopper wheel, alternating with two narrower sweeping pencil beams 118. Since the resolution of an x-ray imaging system that uses a scanning beam is defined by the width of the beam at the point at which it interacts with the target object being imaged, such an imaging system will produce image lines with alternating high and low imaging resolution.

The arrangement of FIG. 9 provides significant advantages over the prior art arrangement of FIGS. 6, 7A-7C, and 8. Rather than only using reduced-width slits and creating all the image lines with higher resolution, there is an advantage in obtaining some of the scan lines with the lower resolution of the greater-width slits. The intensity of the x-ray beam, which is proportional to the solid angle of the slit aperture, is proportional to the slit width. A slit aperture with half the width will pass only half the number of x-rays, resulting in a 40% reduction in the signal-to-noise ratio (SNR) of both the backscatter and transmission images. This is problematic not just for image quality, but also for the ability of the system to image through steel to detect concealed organic contraband. For a transmission x-ray imaging system, the penetration through a material is characterized by the half-value layer (HVL), which corresponds to the decrease in penetration though a material when the x-ray beam intensity is reduced by a factor of two. For example, the HVL for a 120 keV x-ray in steel is about 3.5 mm.

The novel chopper wheel described in this application allows the penetration through steel, the SNR of the image, and the imaging resolution to be simultaneously optimized during a single scan. In the embodiment shown in FIG. 9, the two wide slits 614 with higher x-ray intensity can be used to acquire a lower-resolution, higher-penetration image. The two narrower slits 612 can be used to acquire a higher-resolution, lower-penetration image. The imaging data from the two sets of slits can be stored in separate memory locations, and when the scan is complete, each image can optionally be displayed separately, or displayed side-by-side on the same display screen.

FIG. 10 illustrates how some embodiments disclosed herein can use disk chopper wheels oriented substantially perpendicular to x-ray fan beams as used herein, “substantially perpendicular” indicates perpendicular to within a range in which effective thickness of a chopper disk is not increased significantly, such as not more than 25%, not more than 10%, or not more than 5%. Effective thickness is effective thickness for stopping x-rays. In FIG. 10, the fan beam 104 is oriented in the X-Z plane, while a disk chopper wheel 1002 is situated, and undergoes rotation, in a disk plane that coincides with or is parallel to the X-Y plane. Radial slits 112 and 114, which alternate in this embodiment, just as in the embodiment of FIG. 9, produce alternating larger and smaller pencil beams, such as the smaller pencil beam 118 produced by the slit 112. In the embodiment of FIG. 10, an x-ray tube 1022 directly outputs a fan beam that is incident at the disk chopper wheel 1002. It will be noted that the disk chopper wheel scanning assembly includes a motor 119 for turning the chopper wheel 1002.

FIG. 11 illustrates an alternative embodiment, in which the plane of the disk chopper wheel 1002 is not oriented perpendicular to the fan beam 104, but is instead irradiated and illuminated at a grazing incidence to the incident fan beam. This allows the disk chopper wheel to be much thinner due to the effective thickness of the disk chopper wheel for stopping x-rays, as seen by the incident x-rays, being significantly increased compared with the embodiment of FIG. 10.

In FIG. 11, the x-ray tube 1022 is still oriented with an axis in the Y direction, as in FIG. 10. The fan beam 104 is still oriented in the X-Y plane (the X-Z plane contains the fan beam 104). The plane of rotation of the disk chopper wheel lies at an oblique, non-perpendicular angle Θ with respect to the X-Z plane. The scanning pencil beam 118 is also scanned in the X-Z plane, i.e., the beam plane, as the disk chopper wheel rotates. The disk chopper wheel 1002 is rotated by means of the motor 1190.

The chopper disk 104 is not oriented in either the X-Z plane or the X-Y plane, but, rather, in a disk plane that is at an angle Θ with respect to the beam plane (X-Z plane) of the fan beam 104. The disk plane can also be referred to as a plane of rotation (or rotational plane) of the chopper disk 104, because the disk remains parallel to this plane as it rotates. The disk plane can be parallel to the X axis. By positioning the plane of the rotating disk at an acute (substantially non-perpendicular) angle Θ to the plane of the fan beam, the actual thickness of the disk can be reduced by a factor F=1/sin (θ) while keeping the disk's effective thickness the same. As used herein, “substantially non-perpendicular” indicates that the angle Θ is small enough to increase effective thickness significantly, such as increasing effective thickness by more than 25%, more than 50%, more than 100% (an effective thickness multiplier of 2), more than 200%, or more than 400%.

FIG. 12 is a schematic diagram illustrating an x-ray beam collimation system 1200. The system 1200 includes an x-ray source 122 that is configured to output x-ray radiation 106. The system also includes a collimator 1224 that is configured to receive the x-ray radiation 104106 that is output from the source 122 and to form the x-ray radiation 106 into a collimated x-ray fan beam 104 that is to be received at the at a chopper wheel 1202. The collimated x-ray fan beam 104 has a cross-sectional length 346 and a cross-sectional width 344, as measured at a source side of the chopper wheel 1202. The source side of the chopper wheel 1202 is the side closer to the source 122, while the output side of the chopper wheel 1202 is opposite the x-ray source 122 and is the side through which a pencil beam can be output. The cross-sectional length 346 is greater than the cross-sectional with free 44.

The collimator 1224 includes a width adjuster 1256 that is configured to adjust the cross-sectional width 344 of the collimated x-ray fan beam 104. As described in connection with FIG. 13, the width adjuster 1256 of the collimator can be an x-ray attenuating plate that is configured to block the x-ray radiation and to be translated with respect to the x-ray beam to adjust the cross-sectional width 344. As described in connection with FIG. 14, the width adjuster can be a combination of two attenuating plates. In some embodiments, such as that described in connection with FIG. 15, the width adjuster is an attenuating volume that is not in the form of a collimator plate. The attenuator volume can be configured to block the x-ray radiation, and the volume can define therein a slot configured to pass the x-ray radiation there through in accordance with a degree of alignment of the slot with the x-ray radiation that is received from the x-ray source. The attenuating volume can be configured to be rotated to adjust the cross-sectional width in accordance with the degree of alignment. In a particular case of an attenuating volume, a cylinder with a slot is provided, such as described in connection with FIGS. 16-17 and 18A-18C.

FIG. 12 also illustrates an x-ray scanning system 1201, in which the x-ray beam collimation system 1200 is included, together with a chopper wheel that is a disk chopper wheel. The collimator 1224 is situated between the x-ray source 122 and the disk chopper wheel, in a path of x-ray radiation from the source 122 toward the disk chopper wheel.

The x-ray scanning system 1201 can also optionally include various other features described in connection with FIGS. 1-11. For example, FIG. 12 illustrates that a transmission detector 128 detects larger and smaller pencil beams 120 and 118, respectively, that are transmitted through the target 130. As the target 130 is translated with a target motion 148 with respect to the scanning beam, and as the scanning pencil beam is repeatedly scanned through the target 132 acquire subsequent scan lines, a signal 1232 is provided from the detector 128 to the image generator 136. Images 1238 of variable, selectable resolution, depending on the adjustable cross-sectional width 344, can be output from the image generator 136 and optionally monitored, as illustrated.

FIG. 13 illustrates a collimator 1324 that can be used in the x-ray beam collimation system 1200 illustrated in FIG. 12. While the width adjuster 1256 in FIG. 12 is a schematic representation of various types of width adjusters that may be used in embodiments, the collimator 1324 includes a specific type of width adjuster, namely a single attenuating plate 1360. The plate 1360 is formed of a material that is highly attenuating to x-rays, such as tungsten, lead, steel, or the like. The collimator plate 1358 includes a collimator slot 126 that is system of sufficient width such that, as the attenuating plate 1360 is translated with a translation 1362 from side to side, a width of the collimator slot 126 that is open to the x-ray radiation may be varied. This produces the variation in the cross-sectional with 344 that is shown in FIG. 12. Thus, in FIG. 13, the width adjuster is the translation configuration and attenuating plate 1360, working in tandem with the collimator slot 126.

FIG. 14 illustrates a collimator 1424 that is similar to the collimator 1324 of FIG. 13, except that two attenuating plates 1360 are provided. The plates 1360 work in tandem with coordinating motion 1362. As the plate 1360 are translated together or apart, the slit 126 is widened or narrowed, resulting in the variation in the cross-sectional with 344 illustrated in FIG. 12.

In FIG. 14, the width adjuster 1256 is the combination of two translatable attenuating plates 1360, working in tandem with the slot 126. As will be understood, various mechanical mechanisms may be provided for additional, optional functions. For example, translation control in FIG. 13 and FIG. 14 may be provided by means of an actuator or stage, for example.

FIG. 15 is a perspective-view diagram of a collimator 1524 that includes an x-ray attenuating volume 1562. The volume 1562 may be formed of tungsten, lead, steel, another high-Z material, or the like, sufficient to attenuate x-rays 106 to the desired level. The width adjuster of the collimator 1524 is its configuration, together with any mechanical components that enable such configuration, to be rotated with a rotation 1564. A slot 1526 that is defined in the volume 1562 is configured to pass x-ray radiation there through. However, this occurs only in an aligned state, in which the x-ray radiation 106 is not blocked from traversing the entire slot 1526. As the rotation 1564 occurs, x-ray radiation 106 will be blocked or enabled to pass through, depending on the degree of alignment of the slot 1526 with the x-ray radiation 106. This may be understood further in connection with the special cylindrical x-ray attenuating volume described in connection with FIGS. 16-17 and 18A-18C.

FIG. 16 is a perspective-view illustration of a collimator 1624 that includes a cylindrical x-ray attenuating volume 1662. The volume 1662 includes, and defines therein, a slot 1626 therethrough. The cylindrical volume 1662 can be rotated with a rotation 1664 about an axis shaft 1692 in order to align the slot 1526 with incident x-ray radiation, or misalign the slot, as required, in order to allow more or less of the x-ray radiation to pass therethrough. In this manner, x-ray radiation may be blocked, transmitted in part to achieve a cross-sectional x-ray fan beam width 344 of limited width, or a full cross-sectional width 344, as illustrated in FIG. 12.

FIG. 17 is a profile-view illustration of an embodiment x-ray scanning system that includes an x-ray source 1722, shielding 1672, and a disk chopper wheel 1702, working in combination with the rotating cylindrical collimator 1624 of FIG. 16. The width adjuster of the collimator 1624 includes the structure of the cylindrical volume 1662, working in combination with the shape of the slot 1626, together with their ability to be rotated about the axis shaft 1692.

FIG. 18A is a profile view of the rotating collimator 1624, and particularly the cylindrical x-ray attenuating volume 1662 of the collimator 1624, rotated such that x-rays 106 received from the x-ray source 1722 are permitted to pass through the slot 1626 to the full extent possible, such that the collimated output beam is as wide as possible. The collimated, full output beam can be an x-ray fan beam 104, as illustrated in FIG. 12.

FIG. 18B shows the cylindrical volume 1662 rotated somewhat from the position shown in FIG. 18A, such that part of the x-ray radiation 106 is blocked, resulting in a narrower collimated x-ray fan beam 104, also referred to as a “partial beam.”

FIG. 18C illustrates the volume 1662 rotated sufficiently that none of the x-ray radiation 106 is able to pass through the slot 1626. In other words, there is no collimated output x-ray fan beam 104 (i.e., the cross-sectional width 344 of the collimated x-ray fan beam 104 has been reduced to zero).

FIG. 19 is a schematic illustration showing a series of scan lines formed by the image generator 136 of FIG. 12, corresponding to the smaller pencil beam 118 being scanned over the target 130 repeatedly. Every other one of the scan lines shown in FIG. 19, namely the scan lines 1974, result from actual scans of the pencil beam 118. On the other hand, the image generator 136 of FIG. 12 is further configured to generate interpolated scan lines 1976. The interpolated lines 1976 are formed by the image generator 136 based upon immediately adjacent scan lines 1974, respectively. Thus, because the scan lines are all based upon the smaller pencil beam 118, and image 138 of selectable, higher resolution may be formed by the image generator 136. The same type of the interpolation may be used for scans with the larger pencil beam 120. In the case of the disk chopper wheel 902 of FIG. 9, for example, the interpolation illustrated in FIG. 19 can be useful. As the disk chopper will 902 is rotated, only every other line scan, corresponding to the narrower slits 612, will result in higher resolution scans. However, an image may be formed by using adjacent scanlines corresponding to the narrower slits 612 and creating the interpolated lines as illustrated in FIG. 19 in forming an image. Similarly, in the example of FIG. 9, a full image of lower resolution, using the larger slits 614 and also interpolated scan lines based thereon by the image generator 136, an image of the selectable lower resolution may therefore be formed.

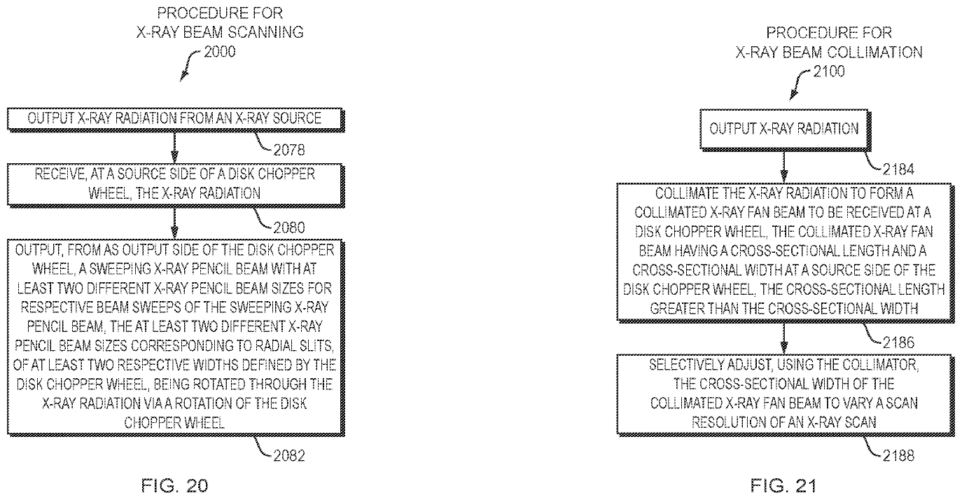

FIG. 20 is a flow diagram illustrating an embodiment procedure 2000 for x-ray scanning. At 2078, x-ray radiation is output from an x-ray source, such as the one illustrated in FIG. 1. At 2080, the x-ray radiation is received at a source side of a disk chopper wheel, such as the disk chopper wheel 102 in FIG. 1. At 2082, a sweeping x-ray pencil beam is output from an output side of the disk chopper wheel. The sweeping x-ray pencil beam is output with at least two different x-ray pencil beam sizes four respective beam sweeps of the sweeping x-ray pencil beam. The at least two different x-ray pencil beam sizes, such as the sizes 118 and 120 illustrated in FIG. 1, or such as the same size as illustrated in FIGS. 8 and 9, respectively, correspond to radial slits of at least two respective widths that are defined by the disk chopper wheel, being rotated through the x-ray radiation via a rotation of the disk chopper wheel.

Variations of the procedure 2000 will be apparent from the embodiments described herein, including the systems and assemblies described in connection with FIGS. 1 and 12, for example. The method can further include detecting radiation scattered from or transmitted through a target as the disk chopper wheel is rotated; outputting signals corresponding to scan lines of an image of the target, each scan line corresponding to a sweep of a radial slits of the at least two respective radial slits through the x-ray radiation; and generating respective images of respective image resolutions using output signals corresponding to sleep of radial slits of respective with of the at least two respective widths.

Furthermore, the procedure can further include generating interpolated scan lines between adjacent scan lines from the one or more radial slits of relatively lesser with, or between adjacent scan lines from the one or more radial slits of relatively greater width, as described in connection with FIG. 19, for example.

FIG. 21 is a flow diagram illustrating an embodiment procedure 2100 for x-ray beam collimation. At 2184, x-ray radiation is output. At 2186, the x-ray radiation is collimated to form a collimated x-ray fan beam to be received at a disk chopper wheel. The collimated x-ray fan beam has a cross-sectional length and a cross-sectional with at a source side of the disk chopper wheel. Further, the cross-sectional length is greater than the cross-sectional with.

At 2188, the cross-sectional width of the collimated x-ray fan beam is selectively adjusted, using the collimator, to vary an x-ray scanning resolution.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. An x-ray scanning assembly comprising:
a disk chopper wheel configured to be irradiated by an x-ray beam and to block x-ray radiation of the x-ray beam, the disk chopper wheel having a rim and a center,
the disk chopper wheel defining therein two or more radial slits extending in radial directions toward the rim and toward the center, the two or more radial slits being configured to pass x-ray radiation of the x-ray beam therethrough,
the two or more radial slits having at least two respective, distinct widths measured perpendicularly to the radial directions.

2. The x-ray scanning assembly of claim 1, wherein the two or more radial slits are three or more radial slits, and wherein at least one of the radial slits has a relatively lesser width of the at least two respective, distinct widths, and wherein at least two of the radial slits have a relatively greater width of the at least two respective, distinct widths.

3. The x-ray scanning assembly of claim 1 or claim 2, wherein the two or more radial slits are three or more radial slits, and wherein at least one of the radial slits has a relatively greater width of the at least two respective, distinct widths, and wherein at least two of the radial slits have a relatively lesser width of the at least two respective, distinct widths.

4. The x-ray scanning assembly of any of claims 1-3, wherein the two or more radial slits are four or more radial slits, and wherein radial slits of the four or more radial slits that are adjacent to each other have different widths of the at least two respective, distinct widths.

5. An x-ray scanning system comprising:
the x-ray scanning assembly of any of claims 1-4;
an x-ray source configured to output the x-ray radiation of the x-ray beam; and
a collimator configured to form the x-ray radiation output from the x-ray source such that the x-ray beam is a collimated x-ray fan beam.

6. The x-ray scanning system of claim 5, wherein the disk chopper wheel is oriented with a wheel plane containing the chopper wheel being substantially perpendicular relative to a beam plane containing the collimated x-ray fan beam.

7. The x-ray scanning system of claim 5, wherein the disk chopper wheel is oriented with a wheel plane containing the chopper wheel being substantially non-perpendicular relative to a beam plane containing the collimated x-ray fan beam.

8. The x-ray scanning system of any of claims 5-7, wherein the collimated x-ray fan beam has a cross-sectional length and a cross-sectional width measured at a source side of the disk chopper wheel, the cross-sectional length greater than the cross-sectional width, the collimator including a width adjustor configured to adjust the cross-sectional width of the collimated x-ray fan beam.

9. The x-ray scanning system of claim 8, wherein the width adjustor comprises at least one x-ray attenuating plate that is configured to block the x-ray radiation and to be translated with respect to the x-ray radiation to adjust the cross-sectional width.

10. The x-ray scanning system of claim 8, wherein the width adjustor comprises an x-ray attenuating volume configured to block the x-ray radiation, the attenuating volume defining therein a slot configured to pass the x-ray radiation therethrough in accordance with a degree of alignment of the slot with the x-ray radiation, and the attenuating volume configured to be rotated to adjust the cross-sectional width in accordance with the degree of alignment.

11. The x-ray scanning system of claim 10, wherein the attenuating volume is a cylinder.

12. An x-ray scanning system comprising:
the x-ray scanning assembly of any of claims 1-4;
a detector configured to detect x-ray radiation scattered from or transmitted through a target as the disk chopper wheel is rotated, the detector configured to output signals corresponding to scan lines of an image of the target, each scan line corresponding to a sweep of a radial slit of the two or more radial slits through the x-ray beam; and
an image generator configured to receive the signals corresponding to scan lines and to generate, selectively:
(i) an image of relatively lower resolution based on signals corresponding to scan lines from one or more radial slits of relatively greater width of the two or more radial slits; and
(ii) an image of relatively higher resolution based on signals corresponding to scan lines from one or more radial slits of relatively lesser width of the two or more radial slits.

13. The x-ray scanning system of claim 12, wherein the image generator is further configured to generate one or more interpolated scan lines (i) between adjacent scan lines from the one or more radial slits of relatively lesser width, or (ii) between adjacent scan lines from the one or more radial slits of relatively greater width.

14. An x-ray beam collimation system comprising:
an x-ray source configured to output x-ray radiation;
a collimator configured to receive the x-ray radiation output from the x-ray source and to form the x-ray radiation into a collimated x-ray fan beam to be received at a chopper wheel, the collimated x-ray fan beam having a cross-sectional length and a cross-sectional width measured at a source side of the chopper wheel, the cross-sectional length greater than the cross-sectional width,
the collimator including a width adjustor configured to adjust the cross-sectional width of the collimated x-ray fan beam.

15. The x-ray beam collimation system of claim 14, wherein the width adjustor comprises at least one x-ray attenuating plate that is configured to block the x-ray radiation and to be translated with respect to the x-ray beam to adjust the cross-sectional width.

16. The x-ray beam collimation system of claim 14, wherein the width adjustor comprises an x-ray attenuating volume configured to block the x-ray radiation, the attenuating volume defining therein a slot configured to pass the x-ray radiation therethrough in accordance with a degree of alignment of the slot with the x-ray radiation, and the attenuating volume configured to be rotated to adjust the cross-sectional width in accordance with a degree of alignment.

17. The x-ray beam collimation system of claim 16, wherein the attenuating volume is a cylinder.

18. An x-ray scanning system comprising the x-ray beam collimation system of any of claims 14-17 and the chopper wheel, wherein the chopper wheel is a disk chopper wheel, and wherein the collimator is situated between the x-ray source and the disk chopper wheel.

19. The x-ray scanning system of claim 18, further including any of the features of claims 1-13.

20. A method of x-ray scanning, the method comprising:
outputting x-ray radiation from an x-ray source;
receiving, at a source side of a disk chopper wheel, the x-ray radiation;
outputting, from an output side of the disk chopper wheel, a sweeping x-ray pencil beam with at least two different x-ray pencil beam sizes for respective beam sweeps of the sweeping x-ray pencil beam, the at least two different x-ray pencil beam sizes corresponding to radial slits, of at least two respective widths defined by the disk chopper wheel, being rotated through the x-ray radiation via a rotation of the disk chopper wheel.

21. The method of claim 20, further comprising:
detecting radiation scattered from or transmitted through a target as the disk chopper wheel is rotated;
outputting signals corresponding to scan lines of an image of the target, each scan line corresponding to a sweep of a radial slit of the at least two respective radial slits through the x-ray radiation; and
generating respective images of respective image resolutions using output signals corresponding to sweeps of radial slits of respective widths of the at least two respective widths.

22. The method of claim 21, further including generating interpolated scan lines (i) between adjacent scan lines from the one or more radial slits of relatively lesser width, or (ii) between adjacent scan lines from the one or more radial slits of relatively greater width.

23. A method of x-ray beam collimation, the method comprising:
outputting x-ray radiation;
collimating the x-ray radiation to form a collimated x-ray fan beam to be received at a disk chopper wheel, the collimated x-ray fan beam having a cross-sectional length and a cross-sectional width at a source side of the disk chopper wheel, the cross-sectional length greater than the cross-sectional width; and
selectively adjusting, using the collimator, the cross-sectional width of the collimated x-ray fan beam to vary a scan resolution of an x-ray scan.

24. An x-ray scanning assembly comprising:
means for outputting x-ray radiation from an x-ray source;
means for receiving, at a source side of a disk chopper wheel, the x-ray radiation; and
means for outputting, from an output side of the disk chopper wheel, a sweeping x-ray pencil beam with at least two different x-ray pencil beam sizes for respective beam sweeps of the sweeping x-ray pencil beam, the at least two different x-ray pencil beam sizes corresponding to radial slits, of at least two respective widths defined by the disk chopper wheel, being rotated through the x-ray radiation via a rotation of the disk chopper wheel.

25. An x-ray beam collimation system comprising:
means for outputting x-ray radiation;
means for collimating the x-ray radiation to form a collimated x-ray fan beam to be received at a disk chopper wheel, the collimated x-ray fan beam having a cross-sectional length and a cross-sectional width at a source side of the disk chopper wheel, the cross-sectional length greater than the cross-sectional width; and
means for selectively adjusting, using the collimator, the cross-sectional width of the collimated x-ray fan beam to vary a scan resolution of an x-ray scan.
